(19) United States
(12) Patent Application Publication
(10) Pub. No.: US 2017/0093963 A1
(43) Pub. Date: Mar. 30, 2017

(54) Method and Apparatus for Allocating Information and Memory

(71) Applicants: Lenovo (Beijing) Co., Ltd., Beijing (CN); Beijing Lenovo Software Ltd., Beijing (CN)

(72) Inventor: Zhengjun LIAN, Beijing (CN)

(73) Assignees: Beijing Lenovo Software Ltd., Beijing (CN); Lenovo (Beijing) Co., Ltd., Beijing (CN)

(21) Appl. No.: 14/974,680

(22) Filed: Dec. 18, 2015

(30) Foreign Application Priority Data
Sep. 25, 2015 (CN) 201510622677.3

(51) Int. Cl. H04L 29/08; G06F 13/42

(52) U.S. Cl. CPC H04L 67/1002; G06F 13/4286

(57) ABSTRACT

A method and an apparatus are provided. After the information of the target task to be processed and the information of the target server to process the target task is obtained, an instruction is sent to one or more servers to be configured which are selected from a set of servers other than the target server, in a case that memory space required for the target task is greater than currently available memory space of the target server. The one or more servers are instructed to map at least partial memory of the one or more servers to be configured to preset allocation spaces of the one or more servers to be configured, so that the target server accesses the at least partial memory through accessing the allocation spaces. Low efficiency of data processing due to insufficient server memory space for data storage, or abnormality of data processing due to an infeasible program may be reduced.

### CROSS-REFERENCE TO RELATED APPLICATIONS

This application claims priority to Chinese Patent Application No. 201510622677.3 titled “METHOD AND APPARATUS FOR ALLOCATING INFORMATION AND MEMORY”, filed with the Chinese Patent Office on Sep. 25, 2015, which is hereby incorporated by reference in its entirety.

### BACKGROUND

With the arrival of big data era, the amount of data processed by servers is increasing. And as a result, the requirement of memory space in the server increases gradually. However, memory space of the server is limited, and the lack of memory space of the server, when the server processes data, will result in low efficiency of data processing, or even abnormal processing due to an infeasible program.

### SUMMARY

In view of this, a method and an apparatus are provided in the present disclosure, to alleviate low efficiency or abnormity of data processing due to insufficient server memory space for data storage.

To realize the objective described above, a method is provided. The method includes:

obtaining information of a target task to be processed currently and information of a target server to process the target task; and

sending an instruction to one or more servers to be configured which are selected from a set of servers other than the target server, in a case that memory space required for the target task is greater than currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

Preferably, the memory space required for the target task is determined by one of the following steps:

determining the memory space required to process the target task based on preset correspondence between a type of a task and memory space occupation; and

determining the memory space required to process the target task based on historic memory occupation of the target task, wherein the historic memory occupation is a size of memory space used to process the target task before the determining the memory space required to process the target task based on the historic memory occupation of the target task.

Preferably, the one or more servers to be configured are selected from the set of servers other than the target server by selecting the one or more servers to be configured with loads meeting a preset condition based on a current load of each server in the set of servers other than the target server.

Preferably, the preset allocation spaces are memory address spaces in PCIE spaces of the one or more servers to be configured.

Preferably, the method further includes:

configuring at least one PCIE downlink interface in the one or more servers to be configured as a controllable port of the target server after the one or more servers to be configured map at least partial memory of the one or more servers to be configured to preset allocation spaces of the one or more servers to be configured, so that the target server accesses the memory address space in the PCIE space through the PCIE downlink interface.

In another aspect, an apparatus is provided. The apparatus includes:

a processor;

a memory that stores instructions executable by the processor to:

obtain information of a target task to be processed currently and information of a target server to process the target task; and

send an instruction to one or more servers to be configured which are selected from a set of servers other than the target server, in a case that a memory space required for the target task is greater than a currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

Preferably, the information of the target task to be processed currently and the information of the target server to process the target task are obtained by one of the following steps:

obtaining information of a memory space required for processing the target task based on preset correspondence between a type of a task and memory space occupation; and

obtaining information of the memory space required for processing the target task based on historic memory occupation of the target task, wherein the historic memory occupation is a size of the memory space required for processing the target task before the obtaining the information of the memory space required for processing the target task.

Preferably, the one or more servers to be configured are selected from the set of servers other than the target server by selecting, based on a current load of each server in the set of servers other than the target server, one or more servers to be configured with a load meeting a preset condition, in a case that the memory space required for the target task is greater than the currently available memory space in the target server.

Preferably, the preset allocation spaces are memory address spaces in PCIE spaces in the one or more servers to be configured.

Preferably, the apparatus is further configured to configure at least one PCIE downlink interface in the one or more servers to be configured as a controllable port of the target server after the one or more servers to be configured map at least partial memory of the one or more servers to be configured to preset allocation spaces of the one or more servers to be configured, so that the target server accesses the memory address space in the PCIE space through the PCIE downlink interface.

In yet another aspect, an apparatus is provided. The apparatus includes:

a processor;

a memory that stores programs executable by the processor to:

receive an instruction, wherein the instruction is generated in a case that memory space required for processing a target task is determined greater than a currently available memory space in a target server, wherein the target server is a server to process the target task; and

map, in response to the instruction, at least partial memory in currently available memory to a preset allocation space, wherein the allocation space is accessed by the target server to access the at least partial memory.

Preferably, the at least partial memory in the currently available memory is mapped, in response to the instruction, to the preset allocation space by mapping an address of the at least partial memory in the currently available memory to a memory address space in a PCIE space.

It may be known from the technical solution described above that, after the information of the target task to be processed and the information of the target server to process the target task is achieved, an instruction is sent to one or more servers to be configured which are selected from a set of servers other than the target server, in a case that memory space required for the target task is greater than currently available memory space of the target server. The one or more servers are instructed to map their at least partial memory to their preset allocation spaces, so that the target server accesses the at least partial memory through accessing the allocation spaces, and read data through the at least partial memory spaces of the one or more servers to be configured. The available memory space of the target server is increased, a risk of low efficiency or abnormity of the target task processing due to insufficient memory space are reduced.

### BRIEF DESCRIPTION OF THE DRAWINGS

In order to illustrate the technical solution according to the embodiments of the present disclosure more clearly, drawings required in the description of the embodiments are described hereinafter. Obviously, the drawings in the following description are just embodiments of the present disclosure. For those skilled in the art, other drawings may be obtained based on these drawings without any creative work.

FIG. 1A is a flow chart of a method according to an embodiment of the present disclosure;

FIG. 1B is a flow chart of a method according to an embodiment of the present disclosure;

FIG. 2 is a flow chart of a method according to another embodiment of the present disclosure;

FIG. 3 is a diagram of a scenario where the method is applied;

FIG. 4 is a diagram of a mapping from memory to memory address space in PCIE space established by the server 32 in FIG. 3;

FIG. 5 is a flow chart of a method according to an embodiment of the present disclosure;

FIG. 6A is a structural diagram of an apparatus according to an embodiment of the present disclosure;

FIG. 6B is a structural diagram of an apparatus according to an embodiment of the present disclosure; and

FIG. 7 is a structural diagram of an apparatus according to an embodiment of the present disclosure.

### DETAILED DESCRIPTION OF THE EMBODIMENTS

A method and an apparatus for allocating information and memory are provided according to the embodiments of the present disclosure. In the method, memory space controlled by different servers is resized dynamically based on the memory space required for a task to be processed on a server, in order to share the memory space among multiple servers, and to reduce the abnormal task processing.

Hereinafter, the technical solution according to the embodiments of the present disclosure is described clearly and completely in conjunction with drawings. Apparently, the described embodiments are only a part of the embodiments of the present disclosure rather than all of the embodiments. All other embodiments obtained by those skilled in the art based on the embodiments of the present disclosure without creative work fall within the scope of protection of the present disclosure.

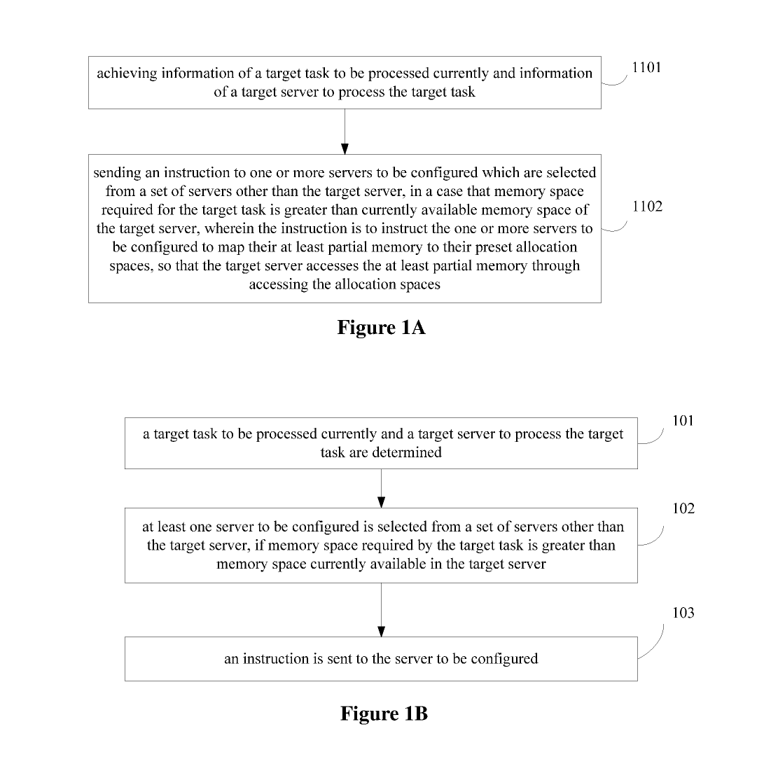

Referring to FIG. 1A, a flow chart of a method according to an embodiment of the present disclosure is shown. The method may include step 1101 to 1102.

In step 1101, information of a target task to be processed currently and information of a target server to process the target task is obtained.

In step 1102, an instruction is sent to one or more servers to be configured which are selected from a set of servers other than the target server, in a case that memory space required for the target task is greater than currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

According to the embodiment of the present disclosure, after the information of the target task to be processed and the information of the target server to process the target task is obtained, an instruction is sent to one or more servers to be configured which are selected from a set of servers other than the target server, in a case that memory space required for the target task is greater than currently available memory space of the target server. The one or more servers are instructed to map at least partial memory of the one or more servers to be configured to preset allocation spaces of the one or more servers to be configured, so that the target server accesses the at least partial memory through accessing the allocation spaces, and read data through the at least partial memory spaces of the one or more servers to be configured. The available memory space of the target server is increased, a risk of low efficiency or abnormity of the target task processing due to insufficient memory space are reduced.

A method in the present disclosure is described. The method is suitable for a control center such as a controller, to regulate resources of multiple servers. The control center may be a separate server or a partial system in a server.

Referring to FIG. 1B, a flow chart of a method according to an embodiment of the present disclosure is shown. The method may include step 101 to 103.

In step 101, a target task to be processed currently and a target server to process the target task are determined.

The control center may determine a task required to be processed and a server required to process the task.

Tasks to be processed are different based on different scenarios where the embodiment of the present disclosure is applied. For example, in a scenario of a data-center, the target task may be a task of data computation.

In step 102, at least one server to be configured is selected from a set of servers other than the target server, if memory space required for the target task is greater than memory space currently available in the target server.

The memory space required for the target task may be memory space of the server required to process the target task.

If the memory space required to process the target task is greater than the memory space currently available in the target server, it concludes that memory space of the server at the present moment may not meet a processing requirement of the target task. In this case, a server to be configured which provides memory space to the target server may be selected from the servers other than the target server according to the embodiment of the present disclosure.

In order to differentiate, the selected server which is to provide the memory space to the target server is referred to as the server to be configured according to the embodiment of the disclosure.

It may be understood that, the target server, the other servers and the control center may be interconnected, for example, through a network or a data line.

In 103, an instruction is sent to the server to be configured.

The instruction is to instruct the server to be configured to map its at least partial memory to its preset allocation space, so that the target server accesses the at least partial memory through accessing the allocation space.

The preset allocation space in the server to be configured may be accessed by the target server. Mapping, by the server to be configured, its at least partial memory to the preset allocation space, is actually establishing an address mapping from the at least partial memory to the allocation space. In this way, the target server may access the at least partial memory space of the server to be configured through accessing an address of the allocation space, and read data through the at least partial memory space.

It may be seen that, for the target server, the at least partial memory of the server to be configured mapped to the preset allocation space is equivalent to extended memory of the target server, thus available memory space of the target server is increased.

According to the embodiment of the present disclosure, after the target task to be processed and the target server to process the target task are determined, the server to be configured may be determined from the set of servers other than the target server if the available memory of the target server does not meet the processing requirement of the target task, and the server to be configured is instructed to map its at least partial memory to its preset allocation space, so that the target server may access the allocation space, and read data through the at least partial memory space of the server to be configured. The available memory space of the target server is increased, a risk of low efficiency or abnormity of the target task processing due to insufficient memory space are reduced.

It may be understood that, the memory space required for the target task may be determined in multiple ways.

In a possible implementation, the memory space required to process the target task may be determined based on preset correspondence between a type of a task and memory space occupation.

The preset correspondence between the type of the task and the memory space occupation may be dynamically studied by the control center based on processing procedures of tasks of different types, so that the control center may determine memory space required for the tasks of different types. A process of dynamical studying is similar to a conventional process, which is not limited herein.

In another possible implementation for determining the memory space required for the target task, the memory space required to process the target task may be determined based on historic memory occupation of the target task. The historic memory occupation is a size of memory space required to process the target task before the present moment. In this implementation, memory occupation required for each task is actually determined based on a historic processing record for the target task. The historic memory occupation may be a specific value, or may be a range for the memory occupation.

In practical applications, the memory space required to process the target task may be determined based on integration of the two implementations for determining the memory space required for the target task.

It may be understood that, in any embodiment of the present disclosure, the set of servers other than the target server refers to a set of servers other than the target server which are controlled by the control center and connected to the target server. The set of servers may include one or more servers.

Furthermore, the at least one server to be configured may be selected from the set of servers in multiple ways. For example, a server may be selected as the server to be configured by the user. Or, one or more servers may be randomly selected from servers with currently unused memory space as the server to be configured. Optionally, in order to realize a load balance and reduce influences on the task processing in the server to be configured, at lease one server to be configured with a load meeting a preset condition may be selected based on a current load of each server in the set of servers other than the target server. For example, in a case that it is required to select five servers to be configured, first five servers with small loads may be selected as the servers to be configured.

It may be understood that, in any embodiment of the present disclosure, after the instruction is sent to the server to be configured, and the server to be configured maps its at least partial memory to its preset allocation space, the server to be configured may further return configuration completion information to the control center, to notify the control center that the server to be configured has completed a configuration task instructed by the control center.

Furthermore, the control center may send a memory extension notification to the target server, to notify the target server that the target server may access the at least partial memory through accessing the allocation space of the server to be configured. For example, the control center may send the memory extension notification to the target server while assigning the target task to the target server.

It should be noted that, there may be one or more selected servers to be configured according to the embodiment of the present disclosure, and a size of accessible memory space provided to the target server by the server to be configured may be set as required.

For example, a size of memory required to be mapped to the allocation space by the server to be configured may be determined based on a difference between available memory space in the target server and the memory space required to process the target task, so that a total size of respective memory space mapped to respective allocation space by servers to be configured is greater than the difference. For example, currently available memory space in the target server is 5G, and the memory space required to process the target task is 10G. Supposing that five servers to be configured are selected, each server to be configured may map memory space of 1G to its preset allocation space, for the target server to use.

Alternatively, the size of the memory space required to be mapped to the allocation space by the server to be configured may be preset as a specified value. For example, each server to be configured maps memory space of 5G to the preset allocation space, for the target server to access.

Of course, in practical applications, the size of the memory required to be mapped to the allocation space by the server to be configured may be determined in other ways, which is not limited herein.

It should be noted that, for any server to be configured, allocation space accessible to other servers controlled by other control centers may be preset in the server to be configured. There may be multiple interfaces for the allocation space, through which other servers are connected to the allocation space, so that other servers may access resources within the allocation space.

Optionally, multiple servers controlled by the control center may be connected to each other through a PCIE bus (PCI Express), and the multiple servers may be connected to the control center through a wireless or wired network. The multiple servers connected through the PCIE bus are equivalent to multiple PCIE devices, and there is PCIE space in each of the multiple servers. In this case, after the server to be configured is determined, the instruction sent by the control center to the server to be configured may be to instruct the server to be configured to map at least partial memory of the server to be configured to the PCIE space (PCIE Space). In this case, after the server to be configured maps its at least partial memory to the PCIE space, the target server may read the PCIT space in the server to be configured through the PCIE bus.

Specifically, the PCIE space may include input-output IO space and memory address space (also referred to as memory space). In this case, the instruction may instruct the server to be configured to map its at least partial memory to the memory address space of the PCIE space.

Furthermore, in practical applications, after sending the instruction to the server to be configured, the control center may perform a configuration control operation, so that the target server knows that the target server may access the PCIE space in the server to be configured.

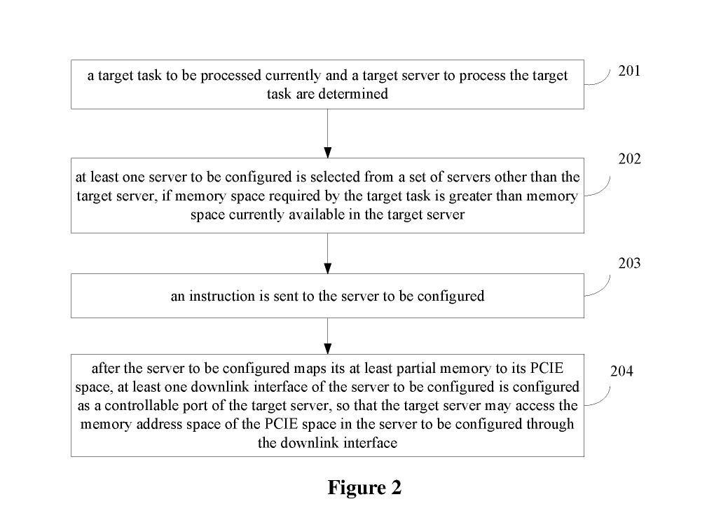

For example, referring to FIG. 2, a flow chart of a method according to another embodiment of the present disclosure is shown. In the method according to the embodiment, multiple servers are connected to each other through a PCIE bus. The method may include step 201 to step 204.

In step 201, a target task to be processed currently and a target server to process the target task are determined.

In step 202, at least one server to be configured is selected from a set of servers other than the target server, if memory space required for the target task is greater than memory space currently available in the target server.

For the two steps described above, relevant description of any above-mentioned embodiment may be referred to, which is not repeated herein.

In step 203, an instruction is sent to the server to be configured.

The instruction is to instruct the server to be configured to map its at least partial memory to memory address space of PCIE space of the server to be configured.

In step 204, after the server to be configured maps at least partial memory of the server to be configured to PCIE space of the server to be configured, at least one downlink interface of the server to be configured is configured as a controllable port of the target server, so that the target server may access the memory address space of the PCIE space in the server to be configured through the downlink interface.

According to the embodiment of the present disclosure, mapping, by the server to be configured, at least partial memory of the server to be configured to PCIE space of the server to be configured, is, mapping, by the server to be configured, at least partial memory space of the server to be configured to the memory address space of PCIE space of the server to be configured.

Optionally, the server to be configured may map partial memory of the server to be configured to the memory address space of the PCIE space through an ATU (Address Translate Unit), so that other servers may read the memory address space of the PCIE space through the PCIE bus.

The downlink interface in the server to be configured may be a PCIE downlink interface.

After the server to be configured maps the memory to the PCIE space, the control center may configure a downlink interface of the server to be configured as a controllable port of the target server, i.e., the downlink interface of the server to be configured is equivalent to a downlink interface of a slave device of the target server, so that the target server may read the memory address space of the PCIE space through the downlink interface.

Specifically, the control center may compile the downlink interface in an End Point mode. In this way, for the target server, the downlink interface of the server to be configured may be regarded as a device, and the target server may be connected to the downlink interface in the End Point mode through the PCIE bus, and may directly read memory mapped by the server to be configured to the PCIE space through the ATU, thus the memory is dynamically increased.

Furthermore, in any of the above-mentioned embodiments, in a case that the target server completes processing of the target task and does not require the memory mapped by the server to be configured to the allocation space , the control center may instruct the server to be configured to cancel the mapping from the memory to the allocation space.

Specifically, in a case that the control center may compile the PCIE downlink interface in the End Point mode, and the memory of the server to be configured is not required, the control center may compile the PCIE downlink interface of the server to be configured in a RC mode through a network, so that the memory of the server to be configured is not mapped to the memory address space of the PCIE space.

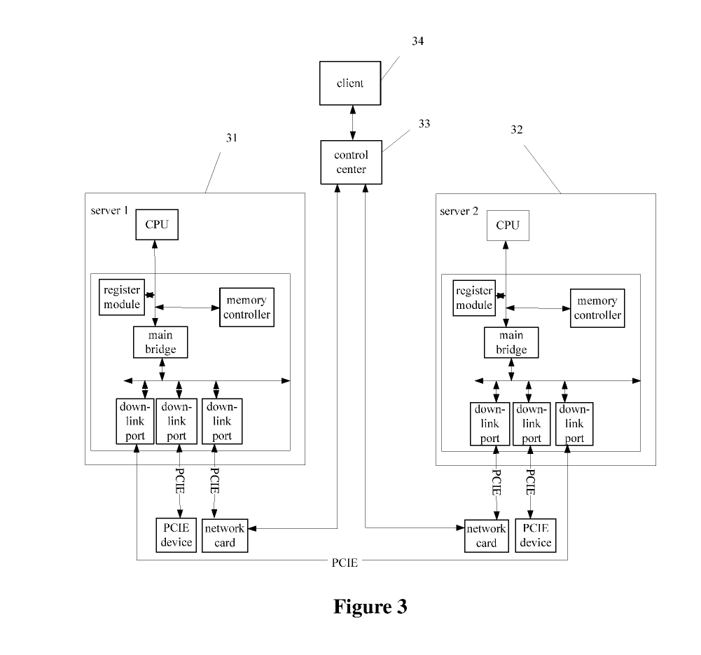

For ease of understanding, it is described in conjunction with a practical application scenario. Referring to FIG. 3, a structural diagram of a system where the method for allocating information in the present disclosure is applied.

In the present disclosure, a case that multiple servers are connected to each other through a PCIE bus and the multiple servers are connected to the control center through a network is taken as an example. For ease of description, only a case that two servers share memory is taken as an example in the embodiment. Thus, only two servers connected to the control center through a network are shown in FIG. 3, i.e., a server 1 and a server 2.

It may be seen from the drawing that, both of the server 31 and server 32 have multiple downlink ports, which may be the downlink interfaces described above. One downlink interface of each of the two servers are connected through the PCIE bus. One downlink interface of the Server 31 and one downlink interface of the server 32 are connected to a control center 33 through a network card, so that the control center 33 may perform control such as resource transfer and task allocation on the server 31 and server 32 through the network.

The system may further include a client 34. The client 34 may access the control center or request to the control center 33 for data processing, so that the control center generates a task to be processed.

Supposing that a target task to be processed currently is determined by the control center and needs to be processed by the server 31, and the control center finds that currently available memory space in the server 31 is insufficient to process the target task, the control center will send an instruction to the server 32. Further supposing that, besides the available memory space, the server 31 further needs memory space of 5G, and the server 32 may share available memory space of 5G, then the control center instructs the server 32 to map the memory space of 5G to memory address space of PCIE space in the server 32. In this case, the server 32 will be controlled to select memory space of 5G from memory and establish a mapping from the memory space of 5G to the memory space of the PCIE space.

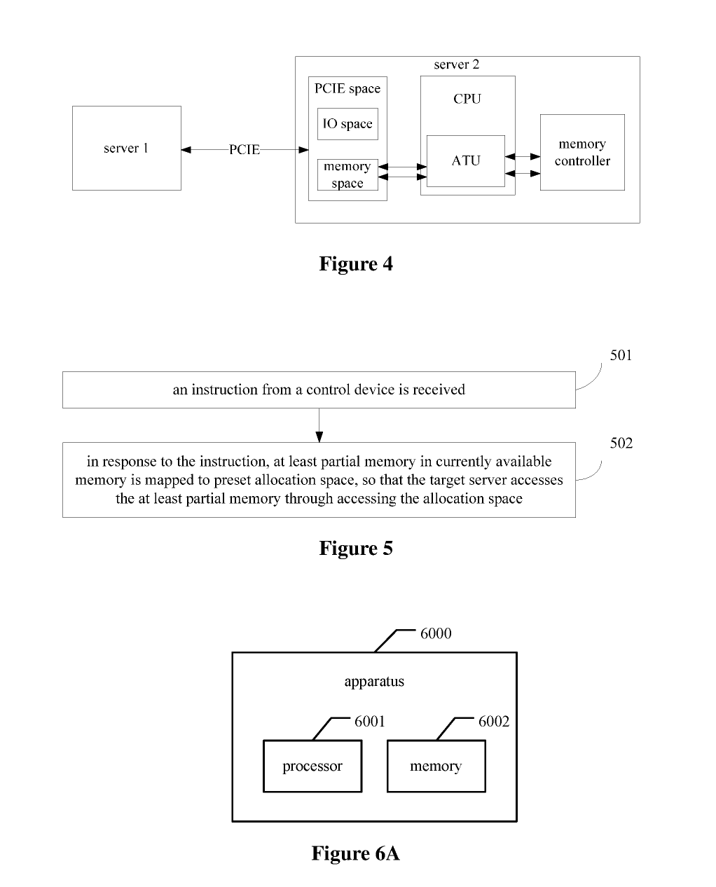

For the mapping established by the server 32 and access to the PCIE memory space in the server 32 by the server 31, FIG. 4 may be referred to.

Based on the foregoing description, the control center may compile one downlink interface of the server 32 in an End Point mode, so that the target server may be connected to the downlink interface set in the End Point mode through the PCIE bus, and may directly read the memory of the server to be configured mapped to the PCIE space through an ATU, thus the memory is dynamically increased.

Referring to FIG. 5, a flow chart of a method according to an embodiment of the present disclosure is shown. The method may be applied to a server. The method may include step 501 to step 502.

In step 501, an instruction from a control device is received.

The control device may be a control center describe above.

The instruction is generated in a case that the control device determines that memory space required for a target task to be processed currently is greater than currently available memory space in a target server. For generation of the instruction, relevant description of the method for allocating information according to the embodiment may be referred to, which is not repeated herein.

The target server is a server required to process the target task.

In step 502, in response to the instruction, at least partial memory in currently available memory is mapped to preset allocation space, so that the target server accesses the at least partial memory through accessing the allocation space.

According to the embodiment of the present disclosure, the server maps at least partial memory of the server to be configured to the preset allocation space based on the instruction from the control device, so that other target servers access the at least partial memory through accessing the allocation space, thus memory of the target server is extended, and abnormity of task processing due to insufficient memory of the target servers are further reduced.

Optionally, mapping the at least partial memory in the currently available memory to the preset allocation space may include:

mapping an address of the at least partial memory in the currently available memory to memory address space in PCIE space.

For an implementation of the embodiment, relevant description of the method for allocating information according to the embodiment may be referred to, which is not repeated herein.

Corresponding to the method for allocating information in the present disclosure, an apparatus for allocating information is further provided according to an embodiment of the present disclosure.

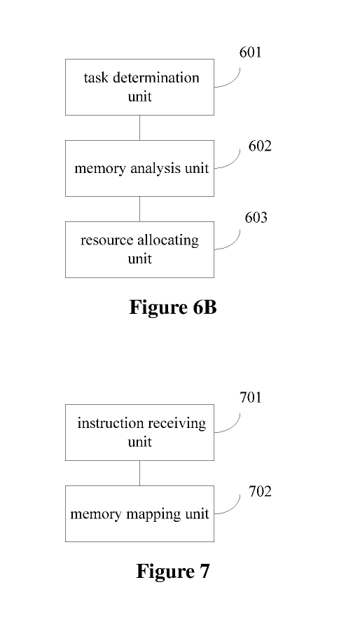

Referring to FIG. 6A, an apparatus 6000 is provided. The apparatus includes:

a processor 6001;

a memory 6002 that stores instructions executable by the processor to:

obtain information of a target task to be processed currently and information of a target server to process the target task; and

send an instruction to one or more servers to be configured which are selected from a set of servers other than the target server, in a case that a memory space required for the target task is greater than a currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

Referring to FIG. 6B, a structural diagram of an apparatus according to an embodiment of the present disclosure is shown. The apparatus may include a task determination unit 601, a memory analysis unit 602 and a resource allocation unit 603.

The task determination unit 601 is configured to determine a target task to be processed currently and a target server to process the target task.

The memory analysis unit 602 is configured to select at least one server to be configured from a set of servers other than the target server, in a case that memory space required for the target task is greater than currently available memory space in the target server.

The resource allocation unit 603 is configured to send an instruction to the server to be configured, where the instruction is to instruct the server to be configured to map at least partial memory of the server to be configured to preset allocation space of the server to be configured, so that the target server accesses the at least partial memory through accessing the allocation space.

Optionally, the task determination unit includes:

a memory determination unit, configured to determine the target task to be processed currently;

a server determination unit, configured to determine the target server to process the target task.

The memory determination unit includes one or more of a first memory determination subunit and a second memory determination subunit.

The first memory determination subunit is configured to determine memory space required to process the target task based on preset correspondence between a type of a task and memory space occupation.

The second memory determination subunit is configured to determine the memory space required to process the target task based on historic memory occupation of the target task, where the historical memory occupation is a size of memory space required to process the target task before the present moment.

Optionally, the memory analysis unit may include a memory analysis subunit.

The memory analysis subunit is configured to select, based on a current load of each server in the set of servers other than the target server, at least one server to be configured with a load meeting a preset condition, in a case that the memory space required for the target task is greater than the currently available memory space in the target server.

Optionally, the target server and servers in the set of servers are connected through a PCIE bus; and

the preset allocation space is memory address space of PCIE space in the server to be configured.

Optionally, the apparatus for allocating information further includes a port configuration unit.

The port configuration unit is configured to configure at least one PCIE downlink interface in the server to be configured as a controllable port of the target server after the server to be configured maps its at least partial memory to its preset allocation space, so that the target server accesses the memory address space of the PCIE space through the PCIE downlink interface.

In another aspect, corresponding to the method for allocating memory in the present disclosure, an apparatus for allocating memory is further provided in the present disclosure.

Referring to FIG. 7, a structural diagram of an apparatus according to an embodiment of the present disclosure is shown. The apparatus may include an instruction receiving unit 701 and a memory mapping unit 702.

The instruction receiving unit 701 is configured to receive an instruction from a control device, where the instruction is generated in a case that the control device determines that memory space required for a target task to be processed is greater than currently available memory space in a target server, and the target server is a server to process the target task.

The memory mapping unit 702 is configured to, in response to the instruction, map at least partial memory in currently available memory to preset allocation space, so that the target server accesses the at least partial memory through accessing the allocation space.

Optionally, the memory mapping unit includes a memory mapping subunit.

The memory mapping subunit is configured to map an address of at least partial memory in the currently available memory to memory address space in PCIE space.

The embodiments of the present disclosure are described in a progressive manner, with emphasis on differences from other embodiments. For the same or similar parts of the embodiments, one may refer to other embodiments. The description of the device according to the embodiments is simple since it corresponds to the method according to the embodiments, and for related parts, the description of the method may be referred to.

The above description of the embodiments is to allow those skilled in the art to implement or use the disclosure. Various modifications to these embodiments will be apparent to those skilled in the art, and the general principle defined herein may be implemented in other embodiments without departing from the spirit or scope of the disclosure. Therefore, the present disclosure will not be limited to the embodiments described herein, but in accordance with the widest scope consistent with the principle and novel features disclosed herein.

1. A method, comprising:
obtaining information of a target task to be processed currently and information of a target server to process the target task; and
sending an instruction to one or more servers to be configured which are selected from a set of servers other than the target server, in a case that memory space required for the target task is greater than currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

2. The method according to claim 1, wherein the memory space required for the target task is determined by one of the following steps:
determining the memory space required to process the target task based on preset correspondence between a type of a task and memory space occupation; and
determining the memory space required to process the target task based on historic memory occupation of the target task, wherein the historic memory occupation is a size of memory space used to process the target task before the determining the memory space required to process the target task based on the historic memory occupation of the target task.

3. The method according to claim 1, wherein the one or more servers to be configured are selected from the set of servers other than the target server by selecting the one or more servers to be configured with loads meeting a preset condition based on a current load of each server in the set of servers other than the target server.

4. The method according to claim 1,
wherein the preset allocation spaces are memory address spaces in PCIE spaces of the one or more servers to be configured.

5. The method according to claim 4, further comprising:
configuring at least one PCIE downlink interface in the one or more servers to be configured as a controllable port of the target server after the one or more servers to be configured map at least partial memory of the one or more servers to be configured to preset allocation spaces of the one or more servers to be configured, so that the target server accesses the memory address space in the PCIE space through the PCIE downlink interface.

6. An apparatus, comprising:
a processor;
a memory that stores instructions executable by the processor to:
obtain information of a target task to be processed currently and information of a target server to process the target task; and
send an instruction to one or more servers to be configured which are selected from a set of servers other than the target server, in a case that a memory space required for the target task is greater than a currently available memory space of the target server, wherein the instruction is to instruct the one or more servers to be configured to map at least partial memory of the one or more servers to be configured to preset allocation spaces of the one or more servers to be configured, so that the target server accesses the at least partial memory through accessing the allocation spaces.

7. The apparatus according to claim 6, wherein the information of the target task to be processed currently and the information of the target server to process the target task are obtained by one of the following steps:
obtaining information of a memory space required for processing the target task based on preset correspondence between a type of a task and memory space occupation; and
obtaining information of the memory space required for processing the target task based on historic memory occupation of the target task, wherein the historic memory occupation is a size of the memory space required for processing the target task before the obtaining the information of the memory space required for processing the target task.

8. The apparatus according to claim 6, wherein the one or more servers to be configured are selected from the set of servers other than the target server by selecting, based on a current load of each server in the set of servers other than the target server, one or more servers to be configured with a load meeting a preset condition, in a case that the memory space required for the target task is greater than the currently available memory space in the target server.

9. The apparatus according to claim 8, wherein the preset allocation spaces are memory address spaces in PCIE spaces in the one or more servers to be configured.

10. The apparatus according to claim 9, wherein the processor is further configured to configure at least one PCIE downlink interface in the one or more servers to be configured as a controllable port of the target server after the one or more servers to be configured map at least partial memory of the one or more servers to be configured to preset allocation spaces of the one or more servers to be configured, so that the target server accesses the memory address space in the PCIE space through the PCIE downlink interface.

11. An apparatus, comprising:
a processor;
a memory that stores programs executable by the processor to:
receive an instruction, wherein the instruction is generated in a case that memory space required for processing a target task is determined greater than a currently available memory space in a target server, wherein the target server is a server to process the target task; and
map, in response to the instruction, at least partial memory in currently available memory to a preset allocation space, wherein the allocation space is accessed by the target server to access the at least partial memory.

12. The apparatus according to claim 11, wherein the at least partial memory in the currently available memory is mapped, in response to the instruction, to the preset allocation space by mapping an address of the at least partial memory in the currently available memory to a memory address space in a PCIE space.
